(19) United States
(12) Patent Application Publication
(10) Pub. No.: US 2002/0159227 A1
(43) Pub. Date: Oct. 31, 2002

(54) Display device having housing fitted with display panel and electronic apparatus having the display device

(76) Inventors: Katsumaru Sasaki, Ome-shi (JP); Atsushi Tatemichi, Higashikurume-shi (JP)

Correspondence Address: Pillsbury Winthrop LLP, Suite 2800, 725 South Figueroa Street, Los Angeles, CA, 90017-5406, US

(21) Appl. No.: 10/094,296

(22) Filed: Mar. 8, 2002

(30) Foreign Application Priority Data
Apr. 27, 2001 (JP) 2001-132939

(51) Int. Cl. G06F 1/16

(52) U.S. Cl. 361/681; 361/683

(57) ABSTRACT

A display device includes a housing having a support wall, a display panel set in the housing, and a plurality of retaining members. The display panel has a display screen and outer peripheral portions surrounding the display screen. The retaining members fix the outer peripheral portions of the display panel to the support wall in a plurality of positions with the display screen between the positions. Each of the retaining members has a first fixing portion fixed to the support wall, second fixing portions fixed to the outer peripheral portions of the display panel, and spring portions connecting the first fixing portion and the second fixing portions.

### CROSS-REFERENCE TO RELATED APPLICATIONS

This application is based upon and claims the benefit of priority from prior Japanese Patent Application No. 2001-132939, filed Apr. 27, 2001.

### BACKGROUND OF THE INVENTION

1. Field of the Invention

The present invention relates to a display device having a housing with a liquid crystal display panel therein and an electronic apparatus such as a portable computer having the display device.

2. Description of the Related Art

A liquid crystal display device that is used in a portable computer, for example, comprises a liquid crystal display panel and a housing that stores the display panel. The liquid crystal display panel is a flat rectangular structure that has a display screen. A metallic frame is attached to the outer peripheral edge portions of the display panel. The frame surrounds the display screen and defines the effective display area of the display screen.

The housing is composed of a display cover and a display mask that is removably connected to the cover. The display cover has a support wall. The support wall is situated behind the liquid crystal display panel. The display mask has a rectangular opening that faces the display screen. The display screen is exposed to the outside of the housing through the opening.

The conventional liquid crystal display panel is fixed to the support wall of the display cover by a pair of retaining members. The retaining members are supported on the frame and are located individually on the left- and right-hand sides of the display screen. Each retaining member is fixed to the support wall by screws. As this is done, the display panel is situated in a predetermined region on the support wall.

Modern portable computers require the use of larger display screens in order to enhance the display quality and visibility of their liquid crystal display devices. Accordingly, the width and height of the liquid crystal display panel tend to increase. With the increase in the size of the display panel, the dimensional tolerance of the panel itself increases, so that the outside dimensions of the panel are susceptible to variation. If the left- and right-hand side portions of the frame that hold the display screen are rigidly fixed to the support wall, an undue load may possibly act on the outer peripheral edge portions of the display panel. Thus, the display screen is inevitably distorted and causes an uneven display.

Conventionally, therefore, the other retaining member is attached to the support wall so that its position can be adjusted after the one retaining member is rigidly fixed to the support wall. More specifically, each of the retaining members has a plurality of through holes that are penetrated by screws, individually. Each through hole of the other retaining member has a diameter much greater than that of each screw, so that a gap is formed between the opening edge portion of the hole and the outer peripheral surface of the screw. Thus, in the conventional liquid crystal display device, the gap is utilized to absorb the dimensional tolerance of the liquid crystal display panel, thereby preventing a load from acting on the panel.

According to this conventional configuration, that end portion of the liquid crystal display panel that corresponds to the other retaining member can freely move by the distance corresponding to the gap. If the width of the display panel is smaller than a given value, the panel is inevitably dislocated toward the one retaining member. If the width of the display panel is greater than the given value, on the other hand, the panel is dislocated toward the other retaining member. In consequence, the liquid crystal display panel cannot be accurately positioned with respect to the display cover.

When the display mask is connected to the display cover to which the liquid crystal display panel is fixed, the respective centers of the opening of the mask and the display screen fail to be aligned, and the display screen is dislocated in the width direction of the housing with respect to the opening. Accordingly, the edge portion of the opening of the display mask sometimes may hang over the effective display area of the display screen, thereby partially covering the effective display area. On other occasions, the edge portion of the opening may deviate from the effective display area of the display screen, leading to the frame that surrounds the screen being exposed through the opening.

### BRIEF SUMMARY OF THE INVENTION

An object of the present invention is to provide a display device in which a display panel and a support wall of a housing can be accurately aligned without failing to absorb the dimensional tolerance of the display panel.

Another object of the present invention is to provide an electronic apparatus having the display device.

Additional objects and advantages of the invention will be set forth in the description which follows, and in part will be obvious from the description, or may be learned by practice of the invention. The objects and advantages of the invention may be realized and obtained by means of the instrumentalities and combinations particularly pointed out hereinafter.

### BRIEF DESCRIPTION OF THE SEVERAL VIEWS OF THE DRAWING

The accompanying drawings, which are incorporated in and constitute a part of the specification, illustrate embodiments of the invention, and together with the general description given above and the detailed description of the embodiments given below, serve to explain the principles of the invention.

FIG. 1 is a perspective view of a portable computer according to an embodiment of the invention;

FIG. 2 is a plan view of a liquid crystal display device showing a liquid crystal display unit fixed to a support wall of a display cover by a pair of retaining members;

FIG. 3 is a plan view of a liquid crystal display device showing spring portions of the retaining members deformed to absorb the dimensional tolerance of a liquid crystal display panel;

FIG. 4 is an enlarged plan view of the liquid crystal display device showing the positional relationship between one of the retaining members and the display panel;

FIG. 5 is an enlarged plan view of the liquid crystal display device showing the spring portions of the one retaining member deformed to absorb the dimensional tolerance of the display panel;

FIG. 6 is a sectional view of the liquid crystal display device taken along line F6-F6 of FIG. 2;

FIG. 7 is a sectional view of the liquid crystal display device taken along line F7-F7 of FIG. 2; and

FIG. 8 is a sectional view of the liquid crystal display device taken along line F8-F8 of FIG. 2.

### DETAILED DESCRIPTION OF THE INVENTION

A portable computer according to an embodiment of the present invention will now be described with reference to the accompanying drawings.

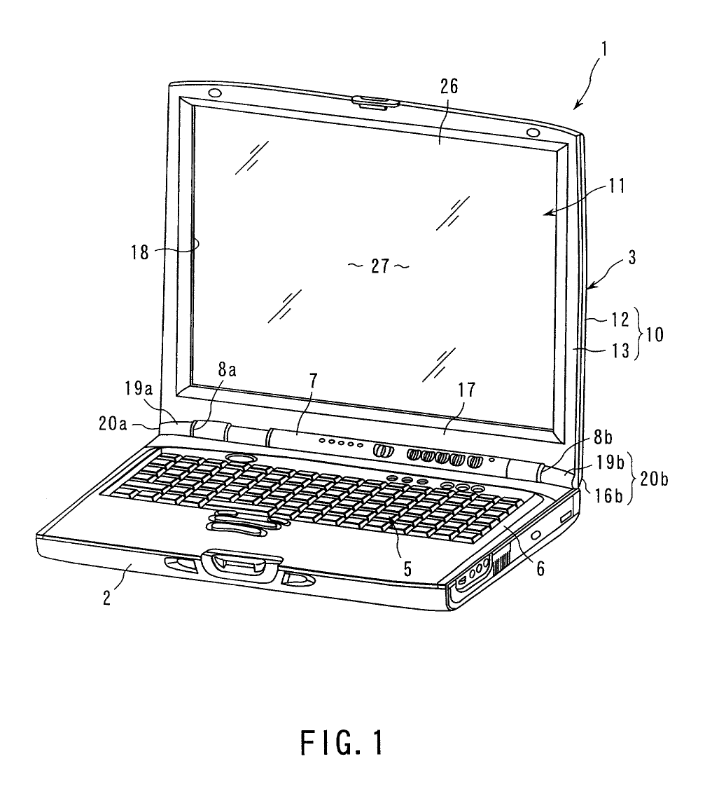

FIG. 1 shows a portable computer 1 for use as an electronic apparatus. The computer 1 comprises a computer main body 2 in the form of a flat box and a liquid crystal display device 3 supported on the main body 2.

The computer main body 2 has an upper surface 6 that carries a keyboard 5 thereon. An upward projection 7 is formed on the rear end portion of the upper surface 6. At the back of the keyboard 5, the projection 7 extends in the width direction of the computer main body 2. The projection 7 has a pair of display supporting portions 8a and 8b. The supporting portions 8a and 8b, each of which is formed of a depression open to the periphery of the projection 7, are spaced in the width direction of the computer main body 2.

The liquid crystal display device 3 comprises a housing 10 and a liquid crystal display unit 11 set in the housing 10. The housing 10 is in the form of a flat box. The housing 10 is composed of a display cover 12 for use as a first cover and a display mask 13 for use as a second cover.

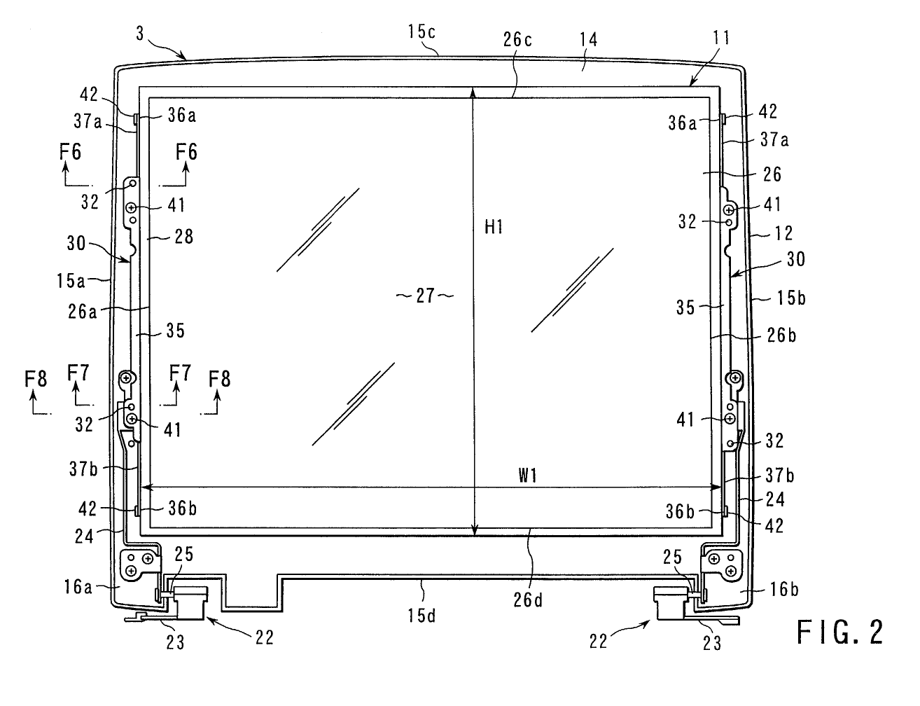

As shown in FIG. 2, the display cover 12 includes a rectangular support wall 14 and first to fourth peripheral walls 15a to 15d that rise from the outer peripheral edge of the support wall 14. Further, the support wall 14 has a pair of leg bodies 16a and 16b. The leg bodies 16a and 16b project from the outer peripheral edge of the support wall 14 and are spaced in the width direction of the display cover 12.

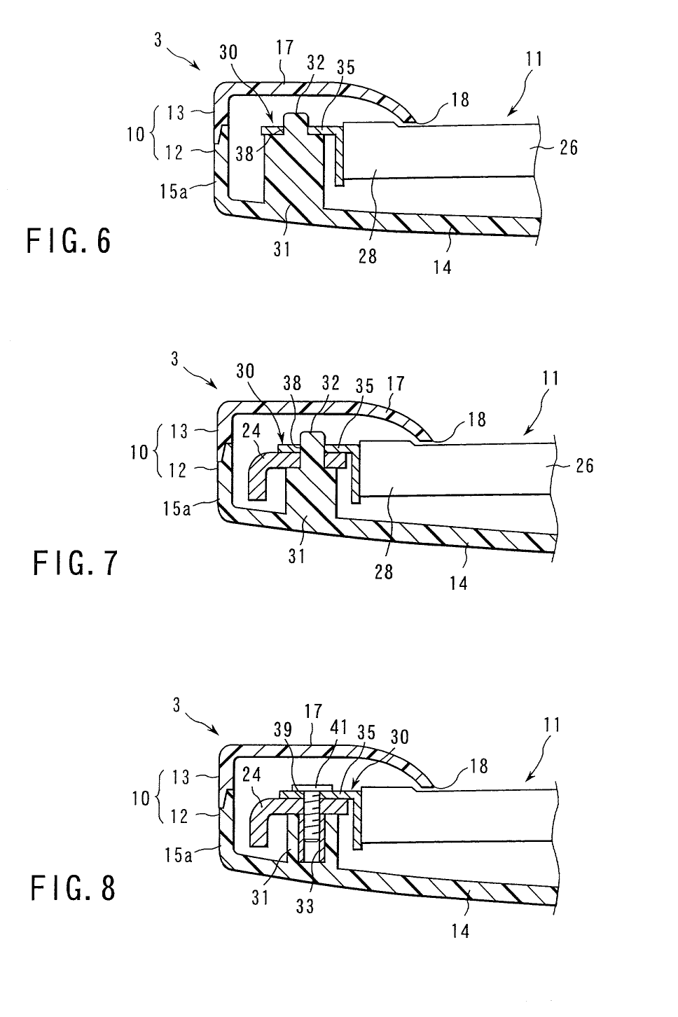

As shown in FIGS. 1 and 6, the display mask 13 has a flat front wall 17. The front wall 17 includes a rectangular opening 18 and a pair of cover portions 19a and 19b. The opening 18 is situated in the central portion of the front wall 17. The cover portions 19a and 19b protrude from the outer peripheral edge of the front wall 17 and are spaced in the width direction of the display mask 13.

The front wall 17 of the display mask 13 is butted against the peripheral walls 15a to 15d of the display cover 12. Thus, the display cover 12 and the display mask 13 are removably connected to each other. When the display mask 13 is connected to the display cover 12, the cover portions 19a and 19b of the mask 13 are butted against the leg bodies 16a and 16b, respectively. The leg bodies 16a and 16b and the cover portions 19a and 19b constitute a pair of leg portions 20a and 20b in conjunction with one another. The leg portions 20a and 20b extend from the housing 10 toward the display supporting portions 8a and 8b of the computer main body 2 and are connected to the main body 2 by hinge units 22, individually.

As shown in FIG. 2, each hinge unit 22 includes a first bracket 23, a second bracket 24, and a hinge pivot 25. The first bracket 23 is set in the projection 7 of the computer main body 2 and fixed to the main body 2. The second bracket 24 is fixed to each of the opposite end portions, left and right, of the support wall 14 by screws. The hinge pivot 25 is located horizontally extending between the first and second brackets 23 and 24 and connects the brackets 23 and 24.

Thus, the housing 10 of the liquid crystal display device 3 is rockable around the respective hinge pivots 25 of the hinge units 22 between a closed position where it is leveled to cover the keyboard 5 from above and an open position where it is raised to expose the keyboard 5.

The liquid crystal display unit 11 is provided with a liquid crystal display panel 26. The display panel 26 is in the form of a rectangle, the width W1 being greater than the height H1. The panel 26 has a display screen 27 that displays images such as characters.

The liquid crystal display panel 26 has first to fourth outer peripheral edge portions 26a to 26d. The first and second outer peripheral edge portions 26a and 26b are situated on the left- and right-hand end portions, respectively, of the display panel 26 with the display screen 27 between them. They extend in the height direction of the display panel 26. The third and fourth outer peripheral edge portions 26c and 26d are situated on upper and lower end portions, respectively, of the display panel 26 with the display screen 27 between them. They extend in the width direction of the display panel 26.

A metallic frame 28 covers the first to fourth outer peripheral edge portions 26a to 26d of the liquid crystal display panel 26. The frame 28 serves to connect the display panel 26 and a chassis (not shown) that supports a backlight and a light guide plate. The frame 28 surrounds the display screen 27 and defines the effective display area of the display screen 27.

The liquid crystal display unit 11 is fixed to the support wall 14 of the display cover 12 by a pair of retaining members 30. As seen from FIGS. 6 to 8, the support wall 14 is provided integrally with a plurality of boss portions 31. The boss portions 31 are located in positions corresponding individually to the left- and right-hand end portions of the liquid crystal display panel 26 and project toward the display mask 13. The boss portions 31 are spaced in the height direction of the display panel 26 in positions adjacent to the left- and right-hand peripheral walls 15a and 15b of the display cover 12. Each boss portion 31 is provided with a positioning protrusion 32 and a tapped hole 33.

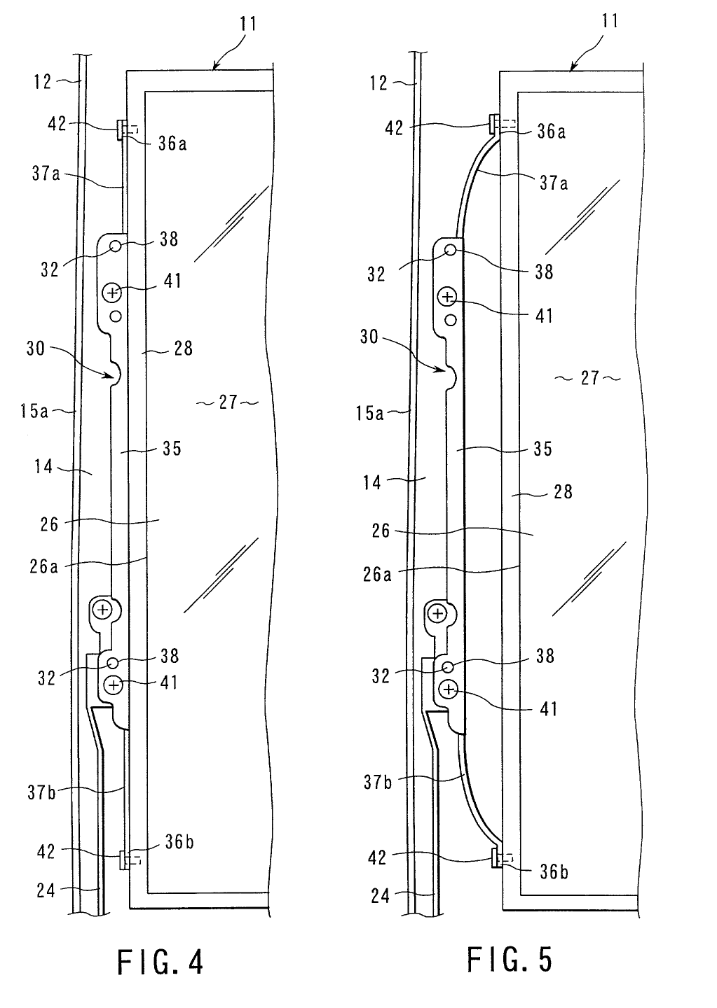

Each of the retaining members 30 is formed of a metallic plate that is prepared by sheet metal stamping. Because these retaining members 30 have a common configuration, the left-hand retaining member 30 will now be described representatively. As is best shown in FIGS. 4 and 5, each retaining member 30 is provided integrally with a first fixing portion 35, a pair of second fixing portions 36a and 36b, and a pair of spring portions 37a and 37b.

The first fixing portion 35 extends along the first outer peripheral edge portion 26a of the liquid crystal display panel 26. It faces the support wall 14 of the display cover 12 and is lapped on the respective upper surfaces of the boss portions 31 in two positions that are spaced in the height direction of the display panel 26. The first fixing portion 35 has fitting holes 38 in which the protrusions 32 are fitted individually and screw guide holes 39 that are aligned with the tapped holes 33, individually. Thus, the first fixing portion 35 is secured to the boss portions 31 in a manner such that the screws 41 are passed individually through the guide holes 39 from the side of the display mask 13 and driven into the tapped holes 33, individually.

As shown in FIG. 8, the second bracket 24 of each hinge unit 22 is interposed between the first fixing portion 35 and the one boss portion 31 that is situated nearer to the leg body 16a. The second bracket 24 is secured to the boss portion 31 by its corresponding screw 41.

The second fixing portions 36a and 36b are situated individually in two positions that are spaced in the height direction of the display panel 26. They are secured to the frame 28 in positions corresponding to the first outer peripheral edge portion 26a of the display panel 26 by screws 42, individually. Thus, the first fixing portion 35 is situated between the second fixing portions 36a and 36b.

The spring portions 37a and 37b extend between the first fixing portion 35 and the second fixing portions 36a and 36b, respectively. In their free state, the spring portions 37a and 37b extend straight along the first outer peripheral edge portion 26a of the liquid crystal display panel 26. They are elastically deformable in the width direction of the display panel 26. The respective urging forces of the spring portions 37a and 37b are equal. If the spring portions 37a and 37b are subjected to any external force, therefore, they are deformed equally.

According to the present embodiment, the paired retaining members 30 are common parts. Thus, the two retaining members 30 at the left- and right-hand end portions of the liquid crystal display panel 26 are attached to the display panel 26 in opposite directions.

The following is a description of procedural steps for setting the liquid crystal display unit 11 in the housing 10 of the portable computer 1 constructed in this manner.

First, the second fixing portions 36a and 36b of the retaining members 30 are fixed to the frame 28 of the liquid crystal display unit 11. Thereupon, the retaining members 30 are attached to the display unit 11 in a manner such that they extend individually along the first and second outer peripheral edge portions 26a and 26b of the liquid crystal display panel 26.

Then, the liquid crystal display unit 11 is placed on the support wall 14 of the display cover 12. Subsequently, the first fixing portion 35 of, for example, the left-hand retaining member 30 is lapped on the respective upper surfaces of the boss portions 31, and the respective protrusions 32 of the boss portions 31 are fitted into the fitting holes 38, individually. Thereupon, the respective positions of the first fixing portion 35 and the boss portions 31 are accurately settled so that the tapped holes 33 and the screw guide holes 39 are aligned with one another. In this state, the screws 41 are driven into the tapped holes 38 through the guide holes 39, individually. In consequence, the left-hand end portion of the liquid crystal display unit 11 is fixed to the support wall 14 by the retaining member 30.

Then, the first fixing portion 35 of the right-hand retaining member 30 is fixed to the boss portions 31 by the screws 41, following the same procedural steps as previously mentioned. Thereupon, the liquid crystal display unit 11 is fixed to the display cover 12 at the left- and right-hand end portions with the display screen 27 between them.

Finally, the front wall 17 of the display mask 13 is fitted into the space that is defined by the peripheral walls 15a to 15d of the display cover 12. Consequently, the effective display area of the display screen 27 is outwardly exposed through the opening 18 of the display mask 13, whereupon assembly of the liquid crystal display device 3 is completed.

The liquid crystal display panel 26 used in this liquid crystal display device 3 has a width W1 greater than its height H1. Therefore, the width W1 of the display panel 26 is liable to substantial variation. If the width W1 of the display panel 26 has a given value, in this case, the spring portions 37a and 37b of the paired retaining members 30 maintain a straight shape such that they extend along the first and second outer peripheral edge portions 26a and 26b of the display panel 26, as shown in FIGS. 2 and 4.

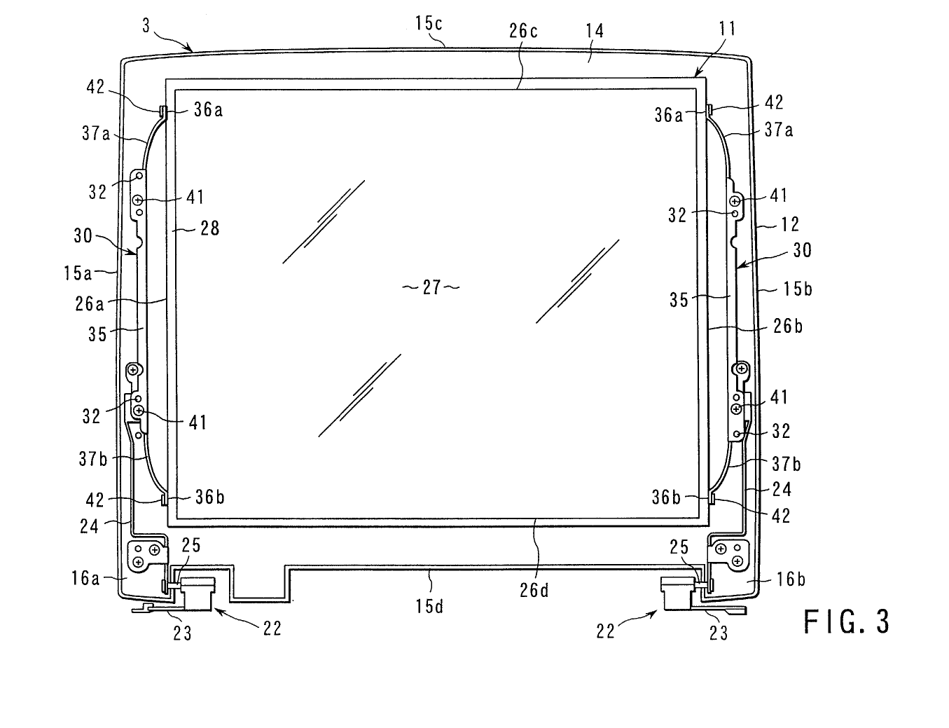

If the width W1 of the liquid crystal display panel 26 is smaller than the given value, on the other hand, the spring portions 37a and 37b of the retaining members 30 are elastically deformed in arcs on the left- and right-hand sides of the display screen 27, as shown in FIGS. 3 and 5. The respective urging forces of the spring portions 37a and 37b of each retaining member 30 are equal. Accordingly, the spring portions 37a and 37b are equally deformed to allow for variations in the width WI of the display panel 26 equally on the left- and right-hand sides of the display screen 27. Thus, the display panel 26 can be accurately fixed in a predetermined position on the support wall 14 without deflection.

When the display mask 13 is secured to the display cover 12 on which the liquid crystal display unit 11 is fixed, the respective centers of the opening 18 of the mask 13 and the display screen 27 of the liquid crystal display panel 26 are aligned accurately. Accordingly, the edge portion of the opening 18 can be prevented from hanging over the effective display area of the display screen 27 and partially covering the effective display area, or the frame 28 that surrounds the display screen 27 can be prevented from being exposed through the opening 18. Thus, the external appearance of the liquid crystal display device 3 can be maintained satisfactorily.

The dimensional tolerance of the liquid crystal display panel 26 is 0.5 mm or thereabouts, even if the panel 26 is of the 15-inch type, for example. For ease of understanding, therefore, FIGS. 3 and 5 show the deformation of the spring portions 37a and 37b, attributable to the tolerance, in an exaggerated manner.

In the embodiment described above, moreover, the left- and right-hand end portions of the liquid crystal display panel are fixed to the support wall by the retaining members. Alternatively, according to the present invention, however, the upper and lower end portions of the display panel may be fixed to the support wall by retaining members, individually. Alternatively, moreover, the four end portions of the display panel, upper, lower, left-hand, and right-hand, may be fixed to the support wall by retaining members, individually.

Furthermore, the display device according to the present invention is not limited to the use in a portable computer, and may be also applied to any other electronic apparatus, such as a desktop computer or a portable DVD player.

Additional advantages and modifications will readily occur to those skilled in the art. Therefore, the invention in its broader aspects is not limited to the specific details and representative embodiments shown and described herein. Accordingly, various modifications may be made without departing from the spirit or scope of the general inventive concept as defined by the appended claims and their equivalents.

What is claimed is:

1. A display device, comprising:
a housing having a support wall;
a display panel set in the housing, the display panel having a display screen and outer peripheral portions surrounding the display screen; and
a plurality of retaining members to fix the outer peripheral portions of the display panel to the support wall in a plurality of positions with the display screen between the positions, each of the retaining members having a first fixing portion fixed to the support wall, second fixing portions fixed to the outer peripheral portions of the display panel, and elastically deformable spring portions connecting the first fixing portion and the second fixing portions.

2. A display device according to claim 1, wherein the outer peripheral portions of said display panel include a first portion and a second portion spaced in a width direction of the display panel, and said retaining members individually fix the first portion and the second portion of the display panel to the support wall.

3. A display device according to claim 1, wherein respective urging forces of the spring portions of said plurality of retaining members are equal.

4. A display device according to claim 1, further including a frame fixed along the outer peripheral portions of the display panel, the second fixing portions of the retaining members being fixed to the frame.

5. A display device, comprising:
a housing having a support wall and an opening opposed to the support wall;
a display panel set in the housing, the display panel having a display screen exposed outside through the opening and outer peripheral portions surrounding the display screen; and
a plurality of retaining members to fix the outer peripheral portions of the display panel to the support wall in a plurality of positions with the display screen between the positions, each of the retaining members having a first fixing portion fixed to the support wall, second fixing portions fixed to the outer peripheral portions of the display panel, and elastically deformable spring portions connecting the first fixing portion and the second fixing portions.

6. A display device according to claim 5, wherein said housing includes a first cover having the support wall and a second cover having the opening, the first cover and the second cover being removably connected to each other.

7. A display device according to claim 5, wherein said display panel has a width and a height, the width being greater than the height.

8. A display device according to claim 7, wherein the outer peripheral portions of said display panel include a first portion and a second portion spaced in a width direction of the display panel, and said retaining members individually fix the first portion and the second portion of the display panel to the support wall.

9. A display device according to claim 5, wherein respective urging forces of the spring portions of said plurality of retaining members are equal.

10. A display device according to claim 5, further including a frame fixed along the outer peripheral portions of the display panel, the second fixing portions of the retaining members being fixed to the frame.

11. An electronic apparatus comprising a computer body and a display device supported on the computer body,
the display device including a housing having a support wall, a display panel set in the housing, the display panel having a display screen and outer peripheral portions surrounding the display screen, and a plurality of retaining members to fix the outer peripheral portions of the display panel to the support wall in a plurality of positions with the display screen between the positions, each of the retaining members having a first fixing portion fixed to the support wall, second fixing portions fixed to the outer peripheral portions of the display panel, and elastically deformable spring portions connecting the first fixing portion and the second fixing portions.

12. An electronic apparatus according to claim 11, wherein said housing includes a first cover having the support wall and a second cover having an opening through which the display screen of the display panel is exposed, the first cover and the second cover being removably connected to each other.

13. A display device, comprising:
a housing having a support wall;
a display panel set in the housing, the display panel having a display screen and outer peripheral portions surrounding the display screen; and
a retaining member to fix the outer peripheral portions of the display panel to the support wall, the retaining member having a first fixing portion fixed to the support wall, second fixing portions fixed to the outer peripheral portions of the display panel, and elastically deformable spring portions connecting the first fixing portion and the second fixing portions.

14. A display device according to claim 13, wherein respective urging forces of the spring portions of said retaining member are equal.

15. A display device according to claim 13, further including a frame fixed along the outer peripheral portions of the display panel, the second fixing portions of the retaining member being fixed to the frame.

16. A display device according to claim 13, wherein the first fixing portion and the second fixing portions are a unitary member.

17. A computer system, comprising:
a main body having a keyboard; and
a display device supported on the main body, the display device including
a housing having a support wall,
a display panel set in the housing, the display panel having a display screen and outer peripheral portions surrounding the display screen, and
a plurality of retaining members to fix the outer peripheral portions of the display panel to the support wall in a plurality of positions with the display screen between the positions, each of the retaining members having a first fixing portion fixed to the support wall, second fixing portions fixed to the outer peripheral portions of the display panel, and elastically deformable spring portions connecting the first fixing portion and the second fixing portions.

18. A computer system according to claim 17, wherein the outer peripheral portions of said display panel include a first portion and a second portion spaced in a width direction of the display panel, and said retaining members individually fix the first portion and the second portion of the display panel to the support wall.

19. A computer system according to claim 17, wherein respective urging forces of the spring portions of said plurality of retaining members are equal.

20. A computer system according to claim 17, further including a frame fixed along the outer peripheral portions of the display panel, the second fixing portions of the retaining members being fixed to the frame.

21. A personal digital assistant, comprising:
a housing having a support wall;
a display panel set in the housing, the display panel having a display screen and outer peripheral portions surrounding the display screen;
a plurality of retaining members to fix the outer peripheral portions of the display panel to the support wall in a plurality of positions with the display screen between the positions, each of the retaining members having a first fixing portion fixed to the support wall, second fixing portions fixed to the outer peripheral portions of the display panel, and elastically deformable spring portions connecting the first fixing portion and the second fixing portions; and
an input interface integrated into the housing.

22. A personal digital assistant according to claim 21, wherein the outer peripheral portions of said display panel include a first portion and a second portion spaced in a width direction of the display panel, and said retaining members individually fix the first portion and the second portion of the display panel to the support wall.

23. A personal digital assistant according to claim 21, wherein respective urging forces of the spring portions of said plurality of retaining members are equal.

24. A personal digital assistant according to claim 21, further including a frame fixed along the outer peripheral portions of the display panel, the second fixing portions of the retaining members being fixed to the frame.

25. A personal digital assistant according to claim 21, wherein the input interface is a button.

26. A personal digital assistant according to claim 21, wherein the input interface is the display screen adapted to receive tactile input.

27. A personal digital assistant according to claim 21, wherein the input interface is a keyboard.

28. A display device, comprising:
a housing having a support wall;
a display panel set in the housing, the display panel having a display screen and an outer peripheral portion surrounding the display screen;
a first spring member attached to the outer peripheral portion and the support wall, having a spring force in a first direction from an attachment at the outer peripheral portion to an attachment at the support wall; and
a second spring member attached to the outer peripheral portion and the support wall, having a second spring force in a second direction opposite the first direction.
